(19) United States
(12) Patent Application Publication
(10) Pub. No.: US 2026/0273547 A1
(43) Pub. Date: Sep. 17, 2026

(54) AIRLESS SPRAY NOZZLE FOR FAN SHAPED SPRAYING

(71) Applicant: Naoko SERA, Tokyo (JP)

(72) Inventor: Hideo SAKUMA, Sagamihara-shi (JP)

(73) Assignee: Naoko SERA, Tokyo (JP)

(21) Appl. No.: 19/234,614

(22) Filed: Jun. 11, 2025

(30) Foreign Application Priority Data
Mar. 14, 2025 (JP) 2025-041872

(51) Int. Cl. B05B 1/04; B22C 9/10; B22C 9/24

(52) U.S. Cl. CPC B05B 1/044; B22C 9/101; B22C 9/24

(57) ABSTRACT

An airless spray nozzle for fan shaped spraying includes a constricting wall that gradually decreases the cross sectional area of a flow channel for a liquid provided rearward and adjacent to an ejection opening of a nozzle main body at the tip of a supply channel. The constricting wall is formed to constrict the flow channel by tracing an arched concave surface toward the ejection opening from the left and right and by tracing a warped roof shaped convex surface toward the ejection opening from above and below. The arched concave surface and the warped roof shaped convex surface are combined such that a tail phenomenon does not occur when a liquid pressure of the liquid is 3.0 MPa (30.6 kgf/cm²) or less. A molding core for molding the nozzle is also provided.

### CROSS REFERENCE TO RELATED APPLICATIONS

The present application claims priority under 35 U.S.C. § 119 to Japanese Patent Application No. 2025-041872, filed on Mar. 14, 2025. The above application is hereby expressly incorporated by reference, in its entirety, into the present application.

### BACKGROUND

The present disclosure is related to a nozzle for spraying liquids such as paint in a fan shape, utilizing only liquid pressure without compressed air (airless spray), and to a core for forming such a nozzle blank. In particular, the present disclosure is related to a nozzle and a core for forming a nozzle blank suitable for spraying liquids such as paint in a fan shape under low liquid pressure without a tail phenomenon occurring.

An important aspect of airless spray painting is to achieve low atomization pressure. If low pressure is realized, the following advantages are exhibited.
1. Paint application efficiency is improved by reducing paint scattering due to overspray and rebound. In addition, the amount of VOC (Volatile Organic Compounds) emissions will be reduced due to the reduced amount of paint and thinner used as a result of improved paint application efficiency.
2. In electrostatic airless spraying by applying electrostatic voltage to an airless sprayer, in addition to further improving paint application efficiency, the atomization performance of an airless sprayer is improved due to the fact that the effect of voltage application on paint atomization is more pronounced in a low pressure region of the spray.
3. A nozzle can be designed with a larger ejection opening, eliminating so-called “nozzle clogging” caused by paint clumps, foreign matter, etc. This is especially advantageous in the management of automatic painting lines.
4. Wear and tear of equipment components, including nozzles, is reduced, enabling long term use of equipment. In addition, an increase in the amount of ejected paint is also suppressed, which is advantageous in controlling a painting thickness in automatic painting processes. The nozzles are made of wear resistant cemented carbide, or alloys of tungsten and cobalt, which are rare metals. In particular, because tungsten is a strategic material and may become difficult to procure, reducing nozzle consumption is important.

Although the advantages of low pressure atomization of paint are obvious, conventional nozzles of this type have a significant disadvantage in that low pressure causes heavy edges or tails of coarse particles to be formed at the two ends of fan shaped atomization.

“Tails” are groups of coarse particles that form on the outer sides of the flat, fan shaped spray of an airless sprayer. The generation of tails leads to poor painting quality and appearance, such as an uneven film thickness. The causes of tails are related to a boundary layer velocity deficit near a nozzle inner wall due to the high viscosity of paint and the overall flow pattern of flow inside a tip. Tails are reduced by increases in paint pressure and decreases in paint viscosity. Therefore, spraying with high liquid pressures of 6.9 to 20.6 MPa (70 to 210 kgf/cm²) is the current practice.

There are several spray nozzles for airless painting which have been improved to obtain a spray pattern without the tail phenomenon under relatively low fluid pressure by causing an ejection opening of a nozzle or the interior near the opening of the nozzle to be of a specific shape.

Japanese Examined Patent Publication No. S41-13033 (Patent Document 1) discloses an invention by Gustav S. Levy and Stanton F. Harvey related to an airless fluid spraying method, in which a restrictor (narrow orifice) is attached to a spray nozzle to accelerate the velocity of a fluid jet introduced into the spray nozzle to a point where it is approximately equal to the velocity of the fluid penetrating the nozzle itself.

Japanese Examined Patent Publication No. S54-34170 (Patent Document 2) discloses an invention by Eric T. Nord, Alvin A. Ladd, and Frederick M. Bosworth related to a spray nozzle, in which a turbulence plate is attached to the spray nozzle to cause turbulence by causing a fluid to collide before it enters the nozzle, thereby reducing side scattering of spray particles.

Japanese Examined Patent Publication No. S61-50655 (Patent Document 3) discloses an invention by Alvin A. Ladd related to an airless spray nozzle, which is a cross cut nozzle with mutual penetration of a wedge shaped groove on an inlet side and a ladder shaped groove on an outlet side to form an orifice opening.

Japanese Examined Patent Publication No. S53-413 (Patent Document 4) discloses an invention by Kihachi Senmura related to a nozzle tip for airless painting, in which both end portions of the edge of a nozzle hole and an arc shaped cutting portion of a lower hole are aligned to eliminate an overlap between the edges of the nozzle hole and the arc-shaped cutting portion. Thereby, the spray speed of paint and the spray energy of paint are increased, paint is sufficiently atomized, and the factors that cause tails to be generated are suppressed.

Japanese Examined Patent Publication No. S47-4799 (Patent Document 5) discloses an invention by Shiro Ito related to a nozzle for an airless painting machine, in which the depth of a V shaped groove is matched to a boundary between a concave surface and a cylindrical surface in order to form a corner angle at the boundary.

Japanese Examined Patent Publication No. H6-7937 (Patent Document 6) discloses an invention by the inventor of the present disclosure related to an atomizing nozzle for airless painting which is equipped with a cavity in the form of a dome shaped recess opening toward the rear of the nozzle, a groove that intersects this recess to form a lip shaped orifice type ejection opening, and a through hole located behind the recess and connected to a paint supply source. A plurality of pairs of inclined surfaces are provided at the inner diameter of the nozzle through which a paint fluid passes, and the shapes and angles of the surfaces are mutually precisely defined.

Japanese Examined Patent Publication No. H7-90186 (Patent Document 7) discloses an invention by the inventor of the present disclosure related to a fan shaped spray nozzle, in which the cross sectional area of a fluid flow channel upstream from a dome shaped concave surface where a lip shaped orifice type ejection opening is formed is increased. The front end of the flow channel which is in contact with the rear end of the dome shaped concave surface has a straight guide section without a step in the direction of a V shaped groove, and a shoulder shaped step in the direction perpendicular to that of the V shaped groove. The V shaped groove is formed to be in a state that does not intersect the step.

Although these conventional technologies promote low liquid pressure spraying, it is difficult to obtain a fan shaped spray pattern without the tail phenomena occurring under low liquid pressure spraying at less than 3.0 MPa (30.6 kgf/cm²).

### SUMMARY

The present disclosure provides a nozzle capable of producing a fan shaped spray without a tail phenomenon occurring even under low liquid pressure of a liquid such as paint of less than 3.0 MPa (30.6 kgf/cm²), and to provide a core for molding that enables production of such a nozzle.

In the description of the configuration of the airless spray nozzle for fan shaped spraying of the present disclosure, the direction of each part of the nozzle will first be defined in the present specification as follows.

For a case in which the fan shaped spray spreads forward and in the vertical direction:
(i) The direction of the spray is designated as a forward direction and the opposite direction is designated as a backward direction.
(ii) The two sides of the fan shaped spray are designated as the left and right sides, respectively, when viewed from behind.
(iii) The two end edges of the fan shaped spray are designated as an upward direction and a downward direction, respectively, when viewed from behind.

The configuration of the spray nozzle for airless fan shaped spraying of the present disclosure does not differ from conventional spray nozzles in the points that it is equipped with a supply channel for a liquid to be sprayed at the rear end of a nozzle body, an ejection opening at the front end for ejecting the liquid, a constricting wall provided rearward and adjacent to the ejection opening that gradually reduces the cross sectional area of a flow channel for the liquid at the tip of the flow channel toward the ejection opening, and a groove at the front end surface of the nozzle body that opens the ejection opening at the bottom and extends in the vertical direction.

The airless spray nozzle for fan shaped spraying of the present disclosure is formed such that the constricting wall traces an arched concave surface from the left to the right toward the ejection opening to narrow the flow channel while tracing a warped roof shaped convex surface from the top to the bottom toward the ejection opening to narrow the flow channel. The shapes of the arched concave surface and the warped convex surface are combined to be within a range in which a liquid pressure of the liquid of less than or equal to 3.0 MPa (30.6 kgf/cm²) does not cause a tail phenomenon to occur.

The spray nozzle for airless fan shaped spraying may be formed such that the radius of curvature of the curve of the arched concave surface increases progressively toward the ejection opening.

The spray nozzle for airless fan shaped spraying of the present disclosure may be formed such that the radius of curvature of the curve of the warped roof shaped convex surface increases progressively toward the ejection opening.

The spray nozzle for airless fan shaped spraying of the present disclosure may have a cycloid curve as the curve of the arched concave surface.

The airless fan shaped atomizing spray nozzle of the present disclosure may have an elliptical ogive curve as the curve of the warped roof shaped convex surface.

The airless spray nozzle for fan shaped spraying for spraying of the present disclosure may have a length La along a central axis of the nozzle body from the beginning of the arched concave surface that constitutes the constricting wall to the front end of the nozzle body and a length Lb along the central axis from the beginning of the warped roof shaped convex surface to the front end of the nozzle body, wherein La≤Lb.

The airless spray nozzle for fan shaped spraying of the present disclosure may be formed such that the groove has a trapezoidal shape in cross section in a plane that intersects the longitudinal direction of the grooves.

The core for molding an airless spray nozzle for fan shaped spraying of the present disclosure is provided with a cylindrical mold surface for forming a supply channel that protrudes forward from a base, and a front end of the cylindrical mold surface is provided with an arched convex surface corresponding to an arched concave surface and a warped roof shaped concave surface corresponding to a warped roof shaped convex surface.

The airless spray nozzle for fan shaped spraying may be used for painting.

The airless spray nozzle for fan shaped spraying of the present disclosure is formed such that the constricting wall traces an arched concave surface from the left and the right sides toward the ejection opening to narrow the flow channel, while tracing a warped convex surface from the top and the bottom sides toward the ejection opening to narrow the flow channel. By appropriately combining the arched concave and convex shapes, spraying without a tail phenomenon occurring can be achieved even under low liquid pressure of 3.0 MPa (30.6 kgf/cm²) or less. Furthermore, by appropriately combining the two shapes, it is possible to obtain a spray that does not the cause tail phenomenon to occur even under a low liquid pressure of 1.0 MPa (10.2 kgf/cm²). This will be described in detail in the section “Embodiments of the Disclosure” below.

In the airless spray nozzle for fan shaped spraying of the present disclosure, by forming the radius of curvature of the curve of the arched concave surface such that it gradually increases toward the ejection opening, the curve becomes that in which pressure from above and below efficiently acts on the flow of liquid such as paint which is constricted toward the ejection opening by the warped roof shaped convex surface from above and below. Thereby, the tail phenomenon can be suppressed under even a lower liquid pressure.

In the airless spray nozzle for fan shaped spraying of the present disclosure, by forming the radius of curvature of the curve of the convex surface of the warped roof shape such that it gradually increases toward the ejection opening, the flow of liquid such as paint is constricted smoothly toward the ejection opening and the constricted liquid flows such that it spreads when it is released from the ejection opening. Thereby, the tail phenomenon can be suppressed further.

In the airless spray nozzle for fan shaped spraying of the present disclosure, by setting the curve of the arched concave surface to be a cycloid curve (a fastest descent curve), w the tail phenomenon can be suppressed under even a further lower fluid pressure.

In the airless spray nozzle for fan shaped spraying of the present disclosure, by setting the curve of the warped roof shaped convex surface to be an elliptical ogive curve, the tail phenomenon can be still further suppressed.

In the airless spray nozzle for fan shaped spraying of the present disclosure, by setting the length La along the central axis from the beginning of the arched concave surface that constitutes the constricting wall to the front end of the nozzle body and the length Lb along the central axis from the beginning of the warped roof shaped convex surface to the front end of the nozzle body to satisfy the relationship La ≤Lb, a combination of the arched concave surface and the warped roof shaped convex surface that further suppresses the tail phenomenon can be obtained.

In the airless spray nozzle for fan shaped spraying of the present disclosure, by forming the groove such that the cross sectional shape of the plane that intersects the longitudinal direction of the groove is trapezoidal, clogging of the nozzle due to paint lumps, etc. can be suppressed.

### BRIEF DESCRIPTION OF THE DRAWINGS

FIG. 1 is a cross sectional view and a longitudinal sectional view of a nozzle according to an embodiment of the present disclosure.

FIG. 2 is a front view of the nozzle according to the embodiment of the present disclosure.

FIG. 3 is a perspective view of the nozzle according to the embodiment of the present disclosure.

FIG. 4 is an image of a spray pattern obtained using the nozzle according to the embodiment of the present disclosure.

FIG. 5 is a diagram for explaining an arched concave curve of the nozzle according to the embodiment of the present disclosure.

FIG. 6 is a collection of diagrams for explaining a warped roof shaped convex curve of the nozzle according to the embodiment of the present disclosure.

FIG. 7 is a perspective view of a core for molding a nozzle according to an embodiment of the present disclosure.

FIG. 8 is a collection of diagrams for explaining a favorable combination of an arched concave and a warped roof shaped convex surfaces of the nozzle of the present disclosure.

FIG. 9 is a collection of photographs of spray patterns obtained using nozzles of conventional technology including those of Patent Documents 1 through 7, and the nozzles of the present disclosure.

FIG. 10 is a collection of photographs of spray patterns obtained using the nozzle of the present disclosure at different liquid pressures.

### DETAILED DESCRIPTION OF THE PREFERRED EMBODIMENTS

An embodiment of the present disclosure will be described below with reference to the attached drawings.

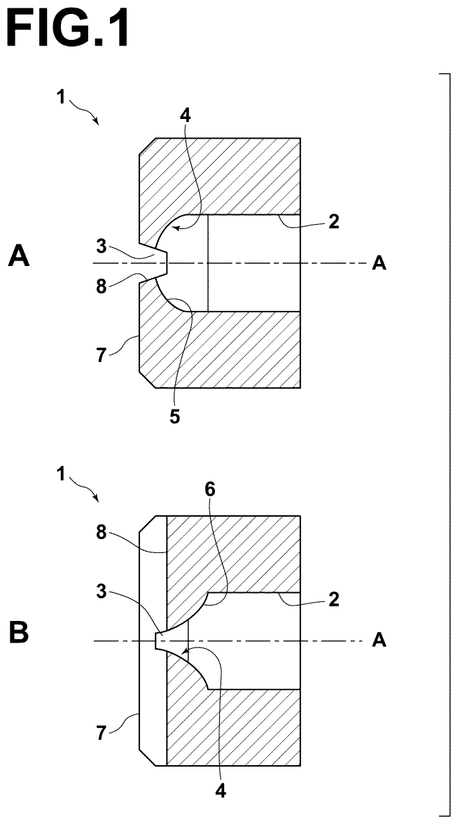

Referring to FIG. 1, the configuration of the airless spray nozzle for fan shaped spraying of the present disclosure will be described. The configuration of the nozzle of the present disclosure does not differ form that of a conventional spray nozzle in the points that a supply channel 2 of a liquid to be sprayed is provided at a rearward position of a central axis A of a nozzle body 1, an ejection opening 3 is provided forward of the supply channel 2 along the central axis A, a constricting wall that gradually reduces the cross sectional area of a flow channel of the liquid toward the ejection opening 3 is formed at the tip of the supply channel 2 before reaching the ejection opening 3, and a groove 8 that opens the ejection opening at the bottom and extends in the vertical direction is formed in a front end surface 7 of the nozzle body 1.

In order to open the ejection opening 3 of the nozzle, the constricting wall is formed to trace an arched concave surface 5 toward the ejection opening 3 from the left and the right (A of FIG. 1) and to trace a warped roof shaped convex surface 6 toward the ejection opening 3 from the top and the bottom (B of FIG. 1) to narrow the flow channel early at a comparatively rearward position. The linear groove 8 that extends in the vertical direction is formed in the front end surface 7 of the nozzle body 1, to open the ejection opening 3 at the bottom thereof. The linear groove 8 is open toward the front, and at the upper and lower ends thereof. In this manner, a recess 4 constituted by the arched concave surface 5 and the warped roof shaped convex surface 6 is formed. As will be described later, the shape of the recess 4 is the key of the present disclosure.

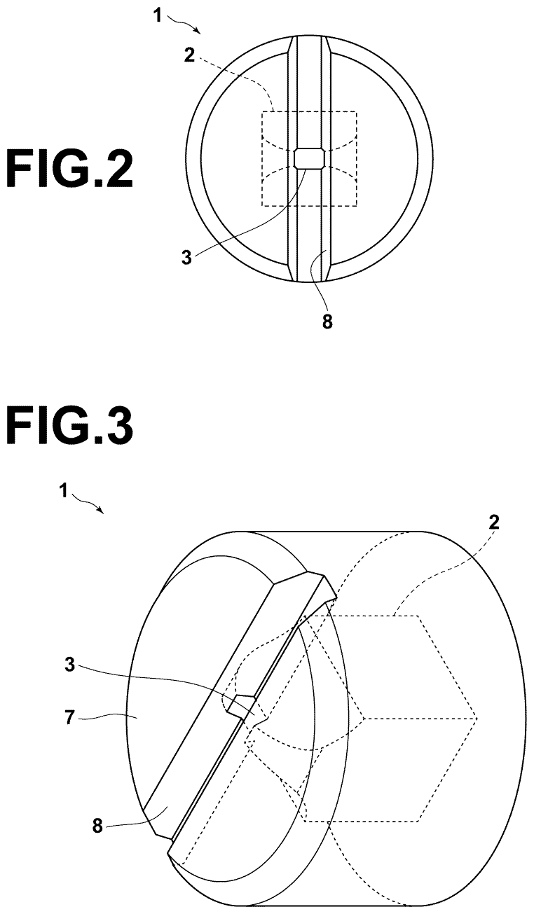

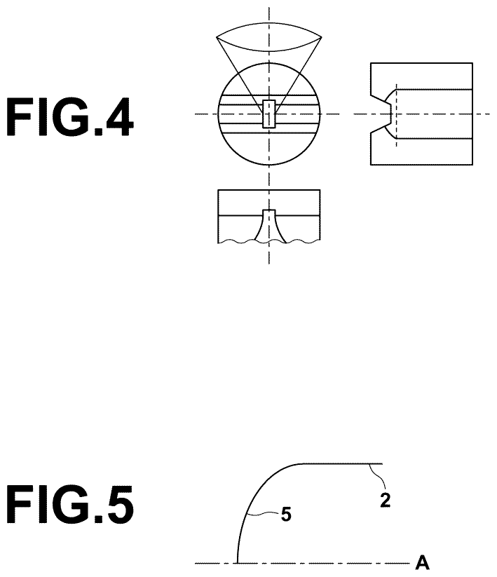

The configuration of the nozzle of the present disclosure was described above based on a longitudinal cross sectional view (FIG. 1). However, understanding of the present disclosure will be facilitated by referring to FIGS. 2 through 4 as well.

The supply channel 2 is not limited to a square as illustrated in FIG. 2, but may be rectangular, circular, elliptical, etc. In addition, the groove 8 does not necessarily have to be open up to both of the ends thereof, but may only be open enough to sufficiently deter the generation of accumulation of a liquid such as paint. Further, the cross sectional shape of the groove 8 is not limited to a trapezoidal shape as illustrated in A of FIG. 1, but may be of a U shape, V a shape, a square, etc.

FIG. 5 illustrates an example of the arched concave surface 5. As illustrated in the figure, the curve of the arch may be formed such that the radius of curvature gradually increases toward the front. Further, the curve of the arch may be a cycloid curve (fastest descending curve) or an involute curve.

The expression “arched concave surface” refers to a surface in which the length of a perpendicular line drawn from one point on the arched concave surface toward the central axis A decreases monotonically toward the direction of the ejection opening, when the nozzle of the present disclosure is viewed in a cross sectional shape that includes the arched curve. As long as this definition is satisfied, the arched concave surface 5 may be a semicircular arch, a parabolic arch, a pointed arch, a pointed Saracen arch, a four centered arch, a lancet arch, a three centered arch, a pseudo three centered arch, a shouldered arch, etc., in addition to the shapes described above.

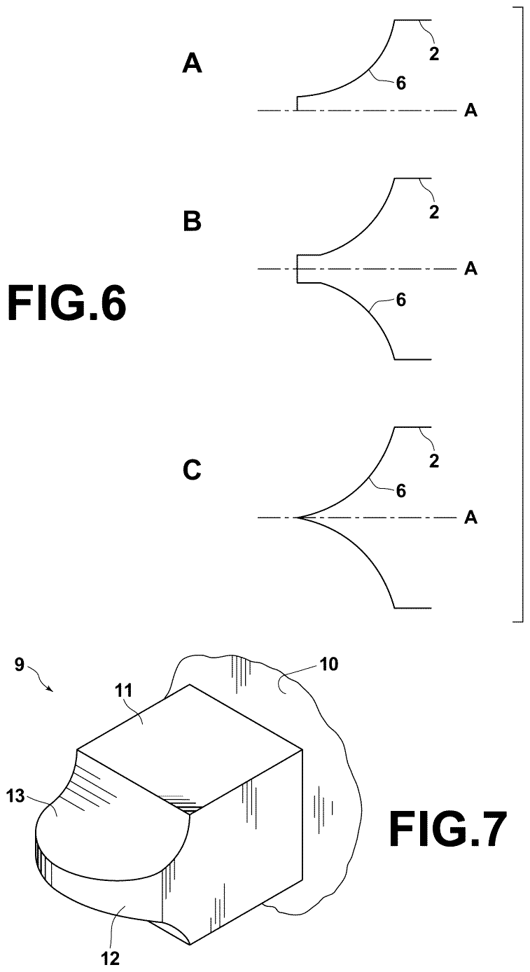

FIG. 6 illustrates an example of the warped roof shaped convex surface 6. As illustrated in the figure, a warped curve may be formed such that the radius of curvature gradually increases toward the front (A of FIG. 5). Further, the warped curve may be an elliptical ogive curve. The area near the forward edge may be nearly horizontal (B of FIG. 5), or conversely, it may remain at an acute angle (C of FIG. 5).

The expression “warped roof shaped convex surface” refers to a surface in which the length of a perpendicular line drawn from one point on the warped roof shaped convex surface toward the central axis A decreases monotonically toward the ejection opening when the nozzle of the present disclosure is viewed in a cross sectional shape that includes the warped roof shaped curve.

The nozzle body 1 is produced from a cemented carbide such as WC—Co or ceramics, and is generally formed by molding a blank before cutting the groove 8. The groove 8 is generally formed by grinding (diamond wheel) after cemented carbide or ceramic sintering. A molding core 9 for molding the blank is illustrated in FIG. 7.

The molding core 9 is provided with a cylindrical mold surface 11 that protrudes forward from a base 10 to form the supply channel 2. The front end of the cylindrical mold surface 11 has an arched convex surface 12 that corresponds to the arched concave surface 5 and a warped roof shaped concave surface 13 that corresponds to the warped roof shaped convex surface 6 described above.

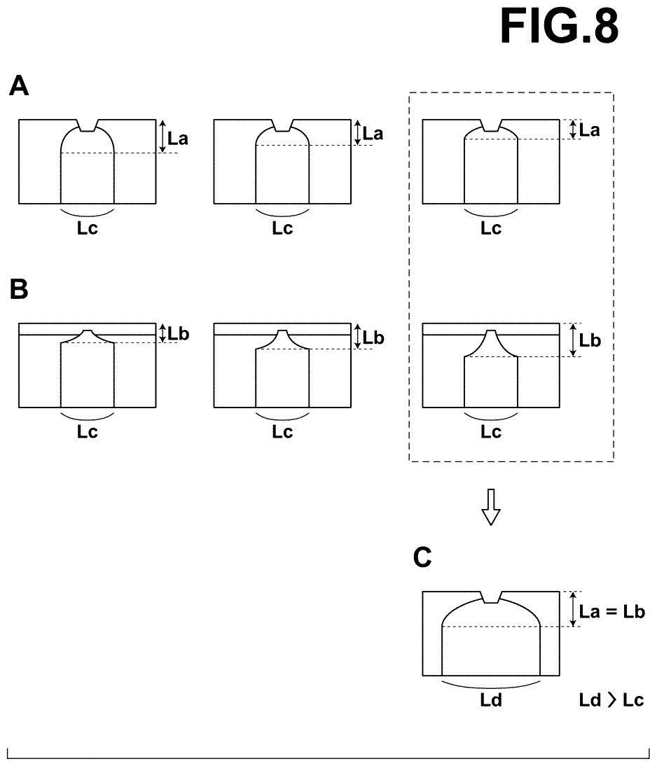

Incidentally, the combination of the arched concave surface 5 and the warped roof shaped convex surface 6, that is, the shape of the recess 4, determines the efficacy of suppressing the tail phenomenon. FIG. 8 is a diagram for explaining this factor. A and C of FIG. 8 are transverse sectional views and B of FIG. 8 is a longitudinal sectional view, respectively. La denotes a length along the central axis A from the beginning of the arched concave surface 5 to the front end of the nozzle body 1, and Lb denotes a length along the central axis A from the beginning of the warped roof shaped convex surface 6 to the front end of the nozzle body 1. One side of the supply channel 2 is common at Lc, that is, the cross section of the supply channel 2 perpendicular to the central axis A is square.

Although not to be bound by any particular theory, a greater force to widen a spray pattern exerted by the arched concave surface 5 is more advantageous in suppressing the taille phenomenon, and the force to widen the spray pattern becomes greater the shorter La is (A of FIG. 8). Meanwhile, a smaller force to narrow the spray pattern exerted by the warped roof shaped convex surface 6 is more advantageous in suppressing the tail phenomenon, and the force to narrow the spray pattern becomes smaller the longer Lb is (B of FIG. 8). If a nozzle body 1 with La=Lb is attempted to be produced while maintaining the advantageous shape of the arched concave surface 5 and the warped roof shaped convex surface 6, the relationship between Ld and Lc will become Ld>Lc as illustrated in C of FIG. 8. That is, the cross section perpendicular to the central axis A of the feed channel 2 becomes a rectangle, which is far from a square. As described previously, the cross sectional shape of the supply channel 2 may be rectangular, but due to the nature of the product, the cross sectional shape of the supply channel 2 is directed closer to a square. In this case, it is understood that the relationship between La and Lb should necessarily be La≤Lb. That is, the length along the central axis A from the beginning of the arched concave surface 5 that constitutes the constricting wall to the front end of the nozzle body 1 should be shorter than the length along the central axis A from the beginning or of the warped roof shaped convex surface 6 to the front end of the nozzle body 1.

Although an embodiment of the present disclosure has been described above, it is a matter of course that the present disclosure is not limited to the configuration of the above embodiment, but can be transformed in any manner within the scope of the concept of the present disclosure as defined in Claim 1 which can be understood by those skilled in the art.

### Examples

In order to confirm the effectiveness of the nozzle of the present disclosure, paint spraying tests were conducted under the following conditions. The nozzles used in the tests were as follows
(A) Standard nozzle produced by Graco Inc.
(B) The nozzle disclosed in Patent Document 1
(C) The nozzle disclosed in Patent Document 2
(D) The nozzle disclosed in Patent Document 3
(E) The nozzle disclosed in Patent Document 4
(F) The nozzle disclosed in Patent Document 5
(G) The nozzle disclosed in Patent Document 6
(H) The nozzle disclosed in Patent Document 7
(I) The nozzle of the present disclosure

In addition, the main spraying conditions were as follows.
Paint utilized: Melamine resin paint, Amilac ZERO White (produced by Kansai Paint Co., Ltd.)
Paint viscosity: 0.03 Pa-s (20 sec/Zahn2)
Spraying distance: 250 mm

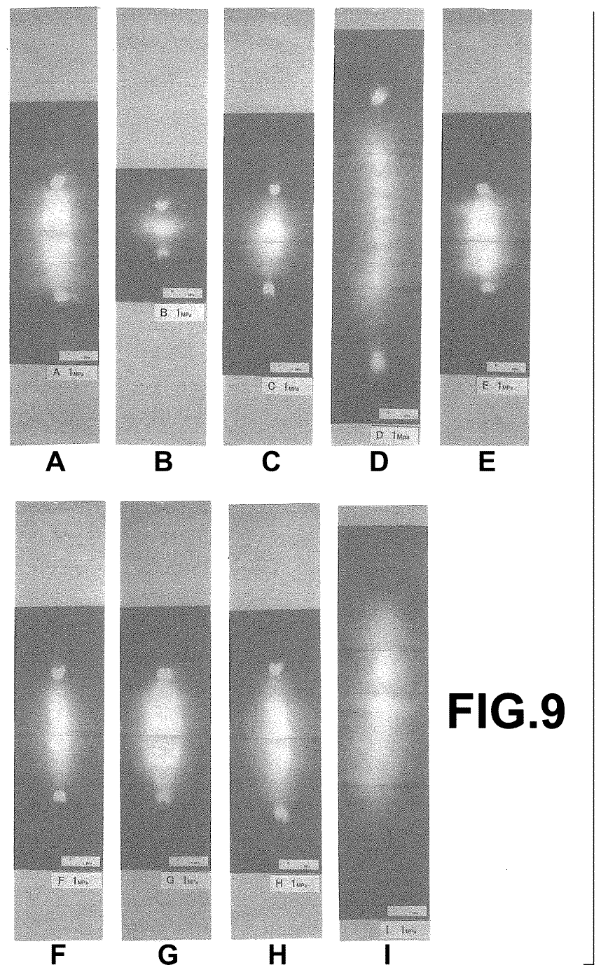

FIG. 9 illustrates spray patterns for cases in which the nozzles (A) through (I) were used to spray the paint under the main spraying conditions and at a spray pressure of 1.0 MPa (10.2 kgf/cm²).

In the spray pattern of nozzle (A), tails occurred above and below the spray pattern. In the spray patterns of nozzles (B) through (H), tails occurred in the same manner as for (A). Therefore, the nozzles (A) through (H) were not sufficient to prevent the generation of tails under low fluid pressure.

In contrast, the spray pattern of nozzle (I) did not generate the tails that occurred in the spray patterns of nozzles (A) through (H). Therefore, the spray nozzle for fan shaped spraying of (I) was able to prevent the generation of tails even under low liquid pressure of 1.0 MPa (10.2 kgf/cm²).

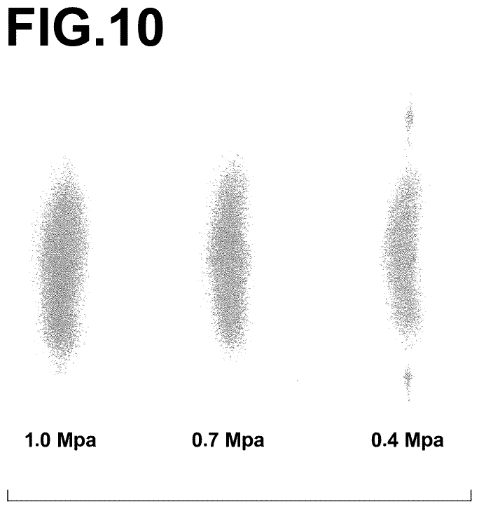

FIG. 10 illustrates spray patterns for cases in which the nozzle of (I) was utilized to spray the paint under the main spraying conditions and at spray pressures of 1.0 MPa (10.2 kgf/cm²), 0.7 MPa (7.1 kgf/cm²) and 0.4 MPa (4.1 kgf/cm²).

Tails were not generated under the spray pressure conditions of 1.0 MPa (10.2 kgf/cm²) and 0.7 MPa (7.1 kgf/cm²). Therefore, even under the spray pressure condition of 0.7 MPa (7.1 kgf/cm²), the occurrence of tails was prevented.

### Industrial Applicability

The airless spray nozzle for fan shaped spraying is useful in the field of painting. It is also suitable for utilization in a wide range of fields other than painting, such as the application of liquids onto electronic equipment, etc., coating of medicaments, etc., and further, agriculture, horticulture, etc.

1. An airless spray nozzle for fan shaped spraying, comprising:
a nozzle body that extends along a flow channel of a liquid to be sprayed;
a supply channel for the liquid to be sprayed provided at a rear end of the nozzle body;
an ejection opening for spraying the liquid provided at a front end of the nozzle body;
a constricting wall provided rearward from and adjacent to the ejection opening that monotonically reduces the cross sectional area of the flow channel for the liquid at an end of the flow channel toward the ejection opening; and
a groove at the front end surface of the nozzle body that opens the ejection opening at the bottom and extends in a vertical direction;
the constricting wall being the inner wall of the nozzle body that corresponds to a contour of a molding core used to form the nozzle body, and being formed to trace an arched concave surface in a horizontal direction to constrict the flow channel and to trace an inwardly convex surface in the vertical direction;
the shapes of the arched concave surface and the inwardly convex surface being combined within a range such that a tail phenomenon does not occur when a liquid pressure of the liquid is less than or equal to 3.0 MPa (30.6 kgf/cm²).

2. The airless spray nozzle for fan shaped spraying as defined in claim 1, wherein:
a radius of curvature of a curve of the arched concave surface monotonically increases toward the ejection opening.

3. The airless spray nozzle for fan shaped spraying as defined in claim 1, wherein:
a radius of curvature of a curve of the inwardly convex surface monotonically increases toward the ejection opening.

4. The airless spray nozzle for fan shaped spraying as defined in claim 2, wherein:
a radius of curvature of a curve of the inwardly convex surface monotonically increases toward the ejection opening.

5. The airless spray nozzle for fan shaped spraying as defined in claim 1, wherein:
a radius of curvature of a curve of the arched concave surface is a cycloid curve.

6. The airless spray nozzle for fan shaped spraying as defined in claim 1, wherein:
a radius of curvature of a curve of the inwardly convex surface is an elliptical ogive curve.

7. The airless spray nozzle for fan shaped spraying as defined in claim 5, wherein:
a radius of curvature of a curve of the inwardly convex surface is an elliptical ogive curve.

8. The airless spray nozzle for fan shaped spraying as defined in claim 1, wherein:
a length La from the beginning of the arched concave surface that constitutes the constricting wall to the front end of the nozzle body along a central axis of the nozzle body and a length Lb from the beginning of the inwardly convex surface that constitutes the constricting wall to the front end of the nozzle body along the central axis of the nozzle body satisfy the relationship La≤Lb.

9. The airless spray nozzle for fan shaped spraying as defined in claim 1, wherein:
the groove is formed such that the cross sectional shape thereof in a plane that intersects with the longitudinal direction of the groove is trapezoidal.

10. A molding core for molding the airless spray nozzle for fan shaped spraying as defined in claim 1, comprising:
a cylindrical mold surface for forming the supply channel that protrudes forward from a base; and
a front end of the cylindrical mold surface provided with an arched convex surface corresponding to the arched concave surface and an inwardly concave surface corresponding to the inwardly convex surface.

11. The airless spray nozzle for fan shaped spraying as defined in claim 1, wherein:
the airless spray nozzle for fan shaped spraying is employed for painting.
